(19) United States
(12) Patent Application Publication
(10) Pub. No.: US 2013/0216682 A1
(43) Pub. Date: Aug. 22, 2013

(54) DEHYDRATED FOOD PRODUCT

(71) Applicants: Patricia Becel, Auvernier (CH); Osvaldo Geromini, Orbe (CH); Pierre-Marc Girot, Liffre (FR); Werner Pfaller, Orbe (CH); Helene Chanvrier, Orbe (CH)

(72) Inventors: Patricia Becel, Auvernier (CH); Osvaldo Geromini, Orbe (CH); Pierre-Marc Girot, Liffre (FR); Werner Pfaller, Orbe (CH); Helene Chanvrier, Orbe (CH)

(73) Assignee: NESTEC S.A., Vevey (CH)

(21) Appl. No.: 13/882,084

(22) PCT Filed: Oct. 28, 2011
(86) PCT No.: PCT/EP11/69002

§ 371 Date: Apr. 26, 2013

(30) Foreign Application Priority Data
Oct. 29, 2010 (EP) 10189520.9

(51) Int. Cl. A23L 1/00

(52) U.S. Cl. CPC A23L 1/0076
USPC 426/589; 426/443; 426/473

(57) ABSTRACT

A dehydrated food product of homogeneous composition in the form of flakes, where the flakes have a porosity of 30 to 70% which assists them dissolve and/or disperse rapidly in water. The flakes are typically used for the preparation of sauces, soups, fonds, gravies, stocks, and consommés.

### TECHNICAL FIELD

This invention relates to new dehydrated food products in the form of flakes, and also to a process for producing these products. In particular, the invention relates to flakes that can dissolve rapidly, essentially instantaneously, in hot or cold water.

### BACKGROUND

Dehydrated food products generally have the serious disadvantage of being difficult to dissolve in hot and cold water, so that particular precautions have to be taken to prevent the formation of lumps in the reconstituted product or to remove lumps once formed by, for example, sieving or using an electric mixer

Typical products are in the form of fine powders, granules or compressed tablets. However, in addition to being difficult to dissolve in water without lump formation, such products tend to have an appearance of having been highly processed or manufactured which can seem artificial or non-natural to a user. Cooks may be put off using such products, particularly when there is a widespread wish from cooks and consumers to be preparing and eating foods that are as natural as possible.

In many kitchens there are now fewer qualified and experienced staff. Often there is little time or patience to wait until water, to which a powdered dehydrated food product is to be added, has reached the optimum temperature for dissolution without lump formation. It is therefore commonplace for the powder to be added at any time while the water is being heated, even on boiling. There is therefore a need for a dehydrated food product to work well at a variety of water temperatures.

There is also a demand for dehydrated food products to be easy to use in the kitchen. For example, many existing products are available in the form of a compressed block or tablet. The cook must use the entire block when preparing the food, or break the block and use only the amount of product the cook wishes to use. This can be a cumbersome step and can often lead to too much or too little product used in the food preparation. Those dehydrated food products available in the form of a loose powder are also not user-friendly in the kitchen. They may need to be weighed or measured in small amounts, spillages are common, and some powdered products suffer from lump formation before use in high humidity locations.

An example of a non-homogeneous powdered dehydrated sauce is described in EP 1 709 876. The sauce is prepared from of a mixture of ingredients where some are powdered, some may be in the form of flakes, and yet others may be chips or granules. This non-homogenous appearance can be displeasing to the cook. Further, there is the problem of segregation where fine particle size ingredients tend to separate out from the larger particle size ingredients in the packaging during storage and transport. This can lead to inconsistency of ingredients and flavours from one food preparation to the next. There is therefore a need for dehydrated food products that have an homogeneous composition such that segregation based on particle size does not matter.

Granulation of dehydrated food products is known. However, granulated products too have drawbacks. Some granulated products do not dissolve rapidly or well in water. This may be due to low porosity of the granules or low surface area available for contact with water compared to powders. Additionally, granulated products tend to have a highly manufactured non-natural appearance which may not be appealing to the user. U.S. Pat. No. 4,060,645 describes an example of an homogeneous dehydrated sauce product in the form of grains.

An object of the present invention is to provide a new homogeneous dehydrated food product which at least goes part way to overcoming one or more of the above disadvantages of existing dehydrated food products.

### SUMMARY OF THE INVENTION

In a first aspect of the invention there is provided a dehydrated food product of homogeneous composition in the form of flakes, which flakes have a porosity of 30 to 70%, preferably 40 to 60%. The shape and size of the flakes may be irregular or regular.

The dehydrated food product may dissolve and/or disperse more or less instantaneously in water at a temperature greater than 20° C., preferably greater than 50° C., and more preferably greater than 80° C.

Typical flakes of the invention each have an average thickness of about 0.8 mm to about 2.3 mm, and top and bottom surface areas in the range of about 10 mm² to about 400 mm². The flakes of a given volume may all be of varying size or may be of a similar size. They may have irregular of regular shapes. Further, the flakes preferably have a bulk density of about 100 g/L to about 300 g/L.

The flakes of the invention may be formed by any suitable means, but are preferably formed by the extrusion of a thermoplastic material through an extruder followed by cutting of the extruded material. The extrusion die of the extruder can influence the physical appearance of the flakes. The die preferably has a cross-sectional shape having multiple slits which may be linked or intersecting slits.

The thermoplastic material used to prepare the flakes will typically contain at least some of flour, starch, fat, salt, sugar, flavours, and maltodextrins, but it will be appreciated that any suitable extrudable material may be used depending on the nature of flake product desired.

The thermoplastic material may be extruded at any suitable temperature and pressure, but usually in the ranges of 60° C. to 125° C. and 15 to 150 bar.

The food product that may be prepared using the flakes of the invention is not restricted to any particular type of food product, but would typically be a sauce, soup, fond, gravy, stock, or consommé.

In a second aspect of the invention there is provided a process for preparing the dehydrated food product flakes of the invention, including the steps of extruding a thermoplastic material through an extrusion die to form an extrudate strand and cutting the strand into pieces to form the flakes.

The process is preferably carried out where the thermoplastic material is formed under sub-atmospheric pressure and at a temperature of at least 60° C.

### BRIEF DESCRIPTION OF THE FIGURES

FIG. 1 shows a dehydrated food product in the form of flakes of the invention.

FIG. 2 shows a longitudinal cut (6 mm×4.7 mm) of a flake of the invention.

FIG. 3 shows a transversal cut (6 mm×2 mm) of the flake of FIG. 2.

FIG. 4 shows a vertical cut (4.7 mm×2 mm) of the flake of FIG. 2.

FIG. 5 shows the dissolution kinetics of flakes and granules.

### DETAILED DESCRIPTION

The present invention provides a dehydrated food product of homogeneous composition in the form of flakes, where the flakes dissolve and/or disperse rapidly in water. The dissolution and dispersion characteristics of the flakes are due in large part to the flakes having a porosity of 30 to 70%, preferably 40 to 60%.

According to this invention, a “flake” is a piece of the food product that is generally thin, such that its thickness is less than its width or length (or diameter in the case of a circular shaped piece), and has opposed surfaces that may be regarded as top and bottom surfaces (depending on the orientation of the piece relative to the horizontal). Flakes may generally be, although not necessarily, flat or curved or have smooth/regular surfaces or irregular surfaces. The circumferential shape of such flakes may also be smooth/regular or irregular.

The term “irregular”, when referring to flakes of irregular shape and size, means non-uniform, uneven and variable such that the individual flakes in a volume of flakes each may have a different shape and/or size compared to other flakes in the volume.

The term “homogenous composition” as used in the claims means a composition having substantially uniformly or evenly dispersed ingredients and may comprise one or more types of particle depending on the number and nature of the ingredients used for formation of the flakes.

The term “dehydrated”, when referring to the food product of this invention, means having a total moisture content of less than 5% by weight. The dehydrated food product may or may not have been prepared by a process that includes a specific step where the moisture content is reduced, i.e. a dehydration step. For example, the reduction in moisture content of the food product may occur during a vacuum extrusion process where the extrudate expands into a reduced pressure environment with concomitant evaporation of water.

The term “rapidly”, when referring to flakes substantially dissolving in water, means rapidly compared with other types of food particulates, such as grains having low porosity, and typically less than 2-3 minutes and more often less than 30 seconds depending on the temperature of the water and the respective volumes of flakes and water.

The term “porosity” means the relative proportion of the volume of voids in a volume of flakes. For example, a flake having a porosity of 20% means that 20% of the flake volume comprises voids (e.g. spaces, holes, gaps etc.).

In the context of this invention, “dissolving” in water means dissolving in the sense of forming a solution in water as well as dispersing in water, so that the resultant liquid is a combination or mixture of solubilised particles and particles in suspension in the water.

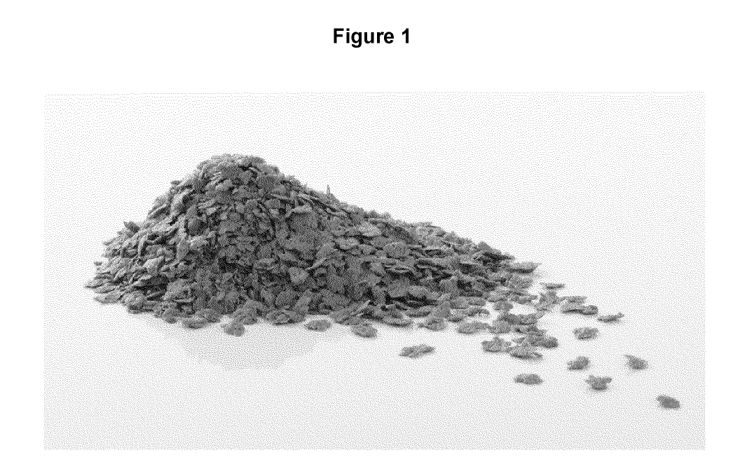

According to the invention, the dehydrated food product is in the form of flakes. This provides the desirable characteristic of a natural appearance. The flakes have an homogeneous composition which means that all the flakes have the same composition and also that the internal composition of each flake is homogeneous. In essence, the flakes are all made from the same material. One example of flakes of the invention is shown in FIG. 1.

The flakes of the invention are porous. The porosity of the flakes is in the range 30 to 70%, but preferably 40 to 60%. This enables the flakes to dissolve and/or disperse rapidly in water. The flakes also preferably have a bulk density between 100 and 300 g/L.

Generally the flakes of the invention have an average top and/or bottom surface area of at least 2 mm², but less than about 400 mm². Typical flakes have an average top and/or bottom surface area in the range of about 8 to 100 mm².

According to a preferred embodiment of the present invention, the dehydrated food product is a dehydrated sauce, soup, fond, gravy, stock, or consommé. The dehydrated food product may be based on extracts or powders of meat, vegetables, fruits, spices, and aroma carrier products.

The dehydrated sauce product according to the invention usually has a water content of up to 5% by weight.

When the dehydrated food product according to the invention is a sauce, it preferably comprises at least meat and/or vegetable based components, flavouring compounds, salt, sugar, hydrocolloids (such as maltodextrin, starch, or flour), and fat or vegetable oil.

The products of the present invention have the advantage that they dissolve well in water, in contrast to dehydrated food products in the form of powders or grains which have a lower porosity and therefore do not dissolve so well. Dissolution of the flakes of the invention occurs readily and with no lump formation even in boiling water.

The invention also provides a process for the production of such a product which comprises extruding a thermoplastic material in powder or paste form at a temperature in the range of 60 to 125° C. and under a pressure in the range of 15 to 150 bar into a chamber having a sub-atmospheric pressure from 0.015 to 0.40 bar, preferably 0.015 to 0.25, and most preferably 0.015 to 0.15, and cutting the extruded product into fragments.

In the context of the invention, the “thermoplastic material” is in the form of a powder or paste material which is either thermoplastic in itself or which contains enough thermoplastic constituents to be capable of softening under the effect of heat, and optionally pressure, and hardening when cooled. The notion of thermoplasticity is easily realised in the case of a paste. In the case of a powder, thermoplasticity signifies that the constituent particles of the powder are capable, under the effect of heat, and optionally pressure, of melting into one another to form a soft, more or less malleable mass.

The thermoplasticity of the material is preferably provided by the presence of fat or oil. This enables the paste to soften on application of heat or the powder to melt thereby forming a soft and malleable mass. The amount of fat or oil in the food product of the invention is usually not more than 50% by weight, preferably 1 to 30% by weight, typically 5 to 15% by weight.

This starting material may be selected from a wide range of food-grade materials used individually or in combination which, more specifically, may be grouped into two categories: materials based on polysaccharides and materials based on proteins. One or the other of these two categories covers, for example, vegetables, seeds, starches, more especially modified starches and dextrins, gums, alginates, meat and fish extracts, proteins of microbiological origin, especially yeast extracts and autolysates, protein hydrolysates and gelatins. The starting material may also contain other ingredients such as spices, flavourings, colorants, fats, sugars, and salts.

In general, preferred starting materials are extracts of vegetables, dextrins, gums, low fat or fat free instant stocks in powder form or mixtures for preparing such stocks, such as mixtures which normally contain, aside from vegetable extracts, yeast autolysates, meat extracts, protein hydrolysates, flavourings, spices, sugar, salt and sodium glutamate.

The thermoplastic starting material in powder or paste form can contain from 1.5 to 20% water by weight. The water content of the starting material is an important factor, but is not critical insofar as it may vary within a wide range, amounting to as much as 20% based on the dry weight of the flakes. It has a direct influence upon the characteristics of the end product and, to prepare a given end product, it may be necessary to modify the water content of the starting material.

The temperature of the starting material in the extruder is important to ensure the plasticity of the starting material and to enable it to pass suitably through the extrusion nozzles. The temperature should be high enough to ensure this plasticity, namely 60° C., but should not cause any deterioration of the treated extract. A temperature of 125° C. may be regarded as an upper limit, but it is normally best not to exceed 105° C. However, the temperature in the vicinity of the nozzles may be above that limit because the residence time of the starting material there is very short. In the absence of special controlling, this temperature is effectively above the temperature prevailing in the actual extruder because the compression forces which act on the starting material, at least when it has to pass through the small orifices constituting the nozzles, cause an increase in temperature and the establishment upstream thereof of a pressure normally amounting to between 15 and 150 bar (approximately 1 to 15 atmospheres) during regular operation. Nevertheless, it is preferred to avoid excessive heating in the vicinity of the nozzles.

In order to provide the end product with a particular shape, it is preferred to use nozzles of non-circular cross-section. In addition, the surface finish of the extruded product, i.e. of the flakes obtained, may be influenced by using cooled or gently heated nozzles or nozzles of which the outer part is cooled or gently heated.

The sub-atmospheric pressure or vacuum prevailing in the chamber downstream of the nozzles is also important. In the absence of this vacuum, the product obtained by extruding a starting material heated to fairly moderate temperatures for operations of this kind would not be able to acquire the expanded texture required. In contrast, the presence of the vacuum downstream of the nozzles causes, on the one hand, a sudden elimination of at least part of the water in the form of steam and the gases initially present in the extract and, on the other hand, a sudden reduction in temperature, leaving the extruded product with the desired texture and rigidity. In practice, the sub-atmospheric pressure is typically 0.015 to 0.400 bar (approximately 0.015 to 0.400 atmospheres).

In preferred embodiments of the invention, the starting material in powder or paste form is introduced by delivery means of any kind, at atmospheric pressure, under pressure or in vacuo and, if necessary, under an inert gas into an extruder. The barrel of the extruder is at a temperature of from 60 to 100° C. The material is then conveyed towards the extrusion nozzle(s) by such means as a piston (for batch operation) or a single or double screw (for continuous operation), at a fixed or variable pitch, and gradually plasticises under the effect of the heat and pressure applied. The heated material then passes through the extrusion nozzles and arrives in the chamber where the vacuum prevails. The chamber may be referred to as an expansion chamber. Under the effect of sudden decompression, some water (up to 50%) and some of the gases present are expelled. At the same time, the temperature of the hot extract falls by several tens of degrees. An expanded product in the form of a porous, relatively rigid strand is thus obtained.

In a first variant, the strand is left to expand completely and is then cut in a regular sequence, for example by means of a rotary blade, to give uniformly dimensioned flat irregular flakes.

In a second preferred variant, the strand is cut in close proximity to the extrusion nozzles and in vacuo, before having completed its expansion. The pellets obtained continue to expand, ultimately giving flakes of comparable size.

In one preferred embodiment of the invention, the starting material used for extrusion is in paste or powder form with any granulometry and with a water content of from 1.5 to 20%. The extruder used is a heated screw extruder kept at 60 to 100° C. and equipped with nozzles. The pressure in the expansion chamber is 0.015 to 0.150 bar. The expanded strand is cut in vacuo immediately it issues from the extrusion nozzles. The portions obtained then drop onto a tray and, having completed their expansion, may be carried outside the expansion chamber through an airlock. These portions generally have an apparent density of from 100 to 300 g/L.

Typical product examples may constitute instant fruit and vegetable extracts or instant lean stocks. They may also be treated with various substances. In particular, the flakes may be impregnated or coated with fats, preferably in a quantity of from 8 to 18% by weight, which dissolve readily in hot or cold water. It is also possible to add other ingredients such as flavourings and colourants.

The process of the present invention has the advantage of providing a dehydrated food product having a colour very similar to the colour of the food which will be obtained after rehydration compared to a food product in the form of a powder. The cook is therefore more likely to feel confident with the preparation of foods from the product of the invention. It has been observed too that the products of the present invention usually present an aroma nearer to the aroma of the rehydrated food compared with those products in the form of a powder known in the art.

### EXAMPLES

The invention is further described with reference to the following examples. It will be appreciated that the invention as claimed is not intended to be limited in any way by these examples.

### Example 1

The following example describes a method for producing flakes of the invention. Ingredients in powder form were mixed, providing an homogeneous dry mix having the following composition:

| | |
|---|---|
| Maltodextrin | 23% |
| Flavours | 18% |
| Starches | 30% |
| Meat powder | 12% |
| Salt | 11% |
| Seasoning | 2% |
| Yeast extract | 4% |

The mix was processed in an extruder at a temperature of up to 80° C. with continuous integration of 8% fat and 3% water in extruder. Pressure was increased to 55-75 bar. The resulting thermoplastic material was forced through a specially shaped die and subsequently cut into flakes of the desired dimensions.

Dehydration of the flakes and porosity of the flakes is achieved through abrupt pressure release of product at exit of the extruder.

Tap density of the flakes was measured to give a desired bulk density of 150-185 g/L. Dissolution in water was measured by dissolving 50 g of flakes in 1 litre of water at 3 temperatures: 100° C., 60° C., 35° C., while agitating constantly with a hand whisk. Dissolution was measured as the time until dissolution of last flake.

Results:
100° C.=6 sec
60° C.=6 sec
35° C.=8 sec

### Example 2

This example compares the porosity and dissolution rates of dehydrated food products in the form of flakes with the same products in the form of granules. Two recipe types are compared, one using flour as a binder and one having no flour.

Recipe A

| | |
|---|---|
| Starches | 33% |
| Meat powder | 6.3% |
| Flavours | 16.2% |
| Vegetables | 5.8% |
| Salt | 10.8% |
| Seasoning | 2.6% |
| Yeast Extract | 5% |
| Flour | 3.9% |
| Maltodextrin | 7.4% |
| Thickener | 2% |
| Sugar | 0% |
| Vegetable oil | 7% |

Recipe B

| | |
|---|---|
| Starches | 31% |
| Meat powder | 2.2% |
| Flavours | 12.6% |
| Vegetables | 2.9% |
| Salt | 13.5% |
| Seasoning | 0.8% |
| Yeast Extract | 9% |
| Maltodextrin | 12.4% |
| Plant extract | 4.2% |
| Sugar | 1.2% |
| Liquid fat | 9% |

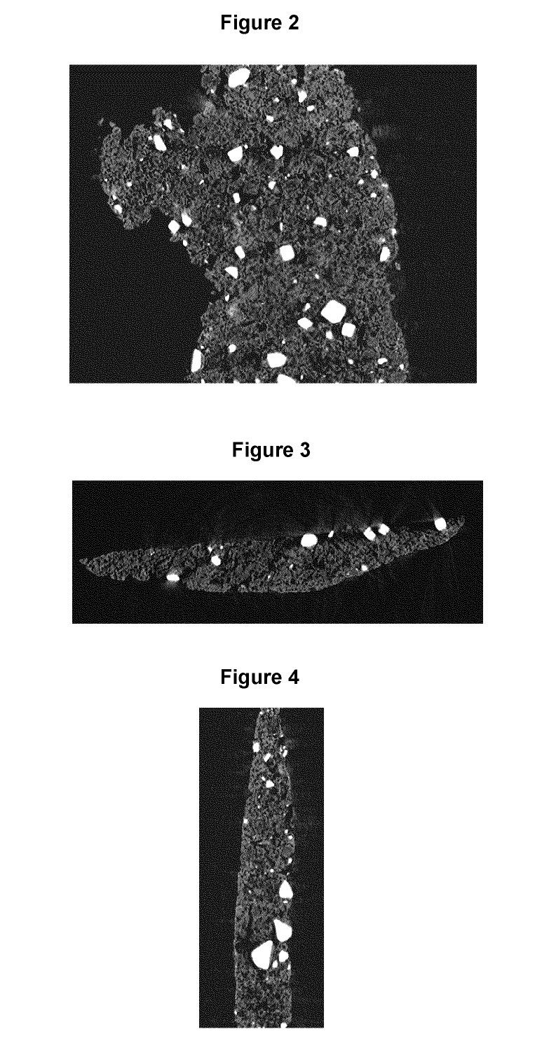

X-ray tomography scans and 3D image analyses were performed on flakes prepared from each recipe. FIGS. 2 to 4 show the structure of a flake prepared using recipe A. The porosity of each flake was calculated as the ratio of the volume of voids in the flake of the volume of the flake.

The porosity of flakes from Recipe A was determined to be 39.8%.

The porosity of flakes from Recipe B was determined to be 52.6%.

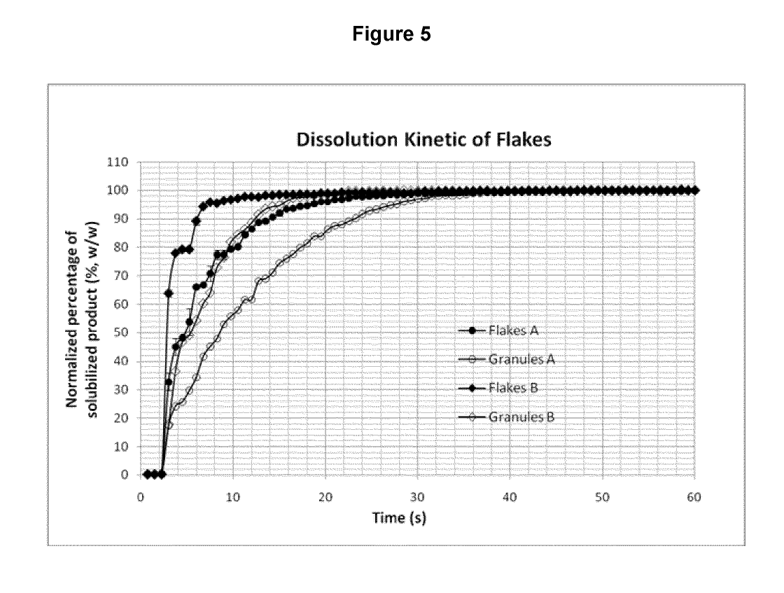

The dissolution kinetics of flakes was performed using a conductivimeter Meterlab (Artsoft, Radiometer Analytical SAS). Flakes (7 g) were dissolved in deionized water (400 mL) at 70° C. The flakes were added to the water instantaneously using a delivery tool. Conductivity frequency measurements were taken using a 12 mm sensor operating at 0.75 Hz. During the measurement, the flakes were stirred using a magnetic stirrer at 500 rpm and a helix stirrer at 100 rpm. FIG. 5 shows the dissolution kinetics of flakes and granules prepared from both Recipes A and B. The graph shows the percentage of solubilised product by weight versus time. It can be seen clearly that in both cases (Recipe A and Recipe B) flakes dissolve more quickly than granules.

### Example 3

This example compares the degree of lump formation when flakes and granules are reconstituted in water to form the fully hydrated food product. The same two recipes from Example 2 were tested.

Dehydrated granules or flakes (50 g) were added to boiling water (1 L). A mechanical whisk operating at 120 rpm was used to reconstitute product. After stirred for 3 min at a temperature above 80° C., the product was sieved through a sieve (1 mm mesh size). Remaining lumps were washed under cold water for ten seconds. The lumps were then dehydrated in an oven at 105° C. at 20 mBar for four hours before being weighed. The results are indicated in the following table.

| | Residue | Residue | Average |
|---|---|---|---|
| | weight | percentage | Percentage |
| Sample | [g] | % | % |
| Granule A | 3.39 | 6.78 | 4.85 |
| | 0.32 | 0.64 | |
| | 3.56 | 7.12 | |
| Granule B | — | 0.00 | 0.00 |
| | — | 0.00 | |
| Flakes A | — | 0.00 | 0.00 |
| | — | 0.00 | |
| Flakes B | — | 0.00 | 0.00 |
| | — | 0.00 | |

Flakes made from Recipe A clearly perform better than granules made from Recipe A, i.e. no lumps were formed when flakes were reconstituted in water. Flakes and granules made from Recipe B (which has no flour as a binder) performed equally.

It is to be appreciated that although the invention has been described with reference to specific embodiments, variations and modifications may be made without departing from the scope of the invention as defined in the claims. Furthermore, where known equivalents exist to specific features, such equivalents are incorporated as if specifically referred to in this specification.

1. A dehydrated food product of homogeneous composition in the form of flakes, the flakes having a porosity of 30 to 70%.

2. A dehydrated food product as claimed in claim 1, where the shape and size of the flakes is irregular.

3. A dehydrated food product as claimed in claim 1, where the shape and size of the flakes is regular.

4. A dehydrated food product as claimed in claim 1, wherein each flake has an average thickness of about 0.8 mm to about 2.3 mm.

5. A dehydrated food product as claimed in claim 1, wherein each flake has top and bottom surface areas of about 10 mm² to about 400 mm².

6. A dehydrated food product as claimed in claim 1, comprising flakes of varying size.

7. A dehydrated food product as claimed in claim 1, comprising flakes of similar size.

8. A dehydrated food product as claimed in claim 1, wherein the flakes have a bulk density of about 100 g/L to about 300 g/L.

9. A dehydrated food product as claimed in claim 1, wherein 50 g of the flakes is capable of dissolving and/or dispersing in 1 liter of water at a temperature of 50° C. in less than 10 seconds.

10. A dehydrated food product as claimed in claim 1, wherein the flakes contain less than 50% by weight fat or oil.

11. A dehydrated food product as claimed in claim 1, wherein the flakes are formed by the extrusion of a thermoplastic material through an extruder followed by cutting of the extruded material.

12. A dehydrated food product as claimed in claim 11, wherein the cross-sectional shape of the die of the extruder has multiple linked or intersecting slits.

13. A dehydrated food product as claimed in claim 11, wherein the thermoplastic material contains flour, starch, fat, salt, and maltodextrins.

14. A dehydrated food product as claimed in claim 11, wherein the thermoplastic material is extruded at a temperature of 60° C. to 125° C.

15. A dehydrated food product as claimed in claim 11, wherein the thermoplastic material is extruded at a pressure of 15 to 150 bar.

16. A dehydrated food product as claimed in claim 1, wherein the food product is used to prepare a product selected from the group consisting of a sauce, soup, fond, gravy, stock, and consommé.

17. A process for preparing dehydrated food product flakes comprising extruding a thermoplastic material through an extrusion die to form an extrudate strand and cutting the strand into pieces to form flakes having a porosity of 30 to 70%.

18. A process as claimed in claim 17, where the thermoplastic material is formed under sub-atmospheric pressure and at a temperature of at least 60° C.
